(19) United States
(12) Patent Application Publication
(10) Pub. No.: US 2023/0406987 A1
(43) Pub. Date: Dec. 21, 2023

(54) THERMOPLASTIC POLYURETHANE, RESIN COMPOSITION CONTAINING THE SAME, AND MOLDED PRODUCT OBTAINED THEREFROM

(71) Applicant: BASE SE, Ludwigshafen am Rhein (DE)

(72) Inventors: Da Hai Yu, SHANGHAI (CN); Yasuyuki Suzuki, Yokkaichi-shi (JP); Sebastian Richter, Shanghai (CN); Stephan Dohmen, Lemfoerde (DE); Dirk Kemfoerde, Lemfoerde (DE)

(73) Assignee: BASE SE, Ludwigshafen am Rhein (DE)

(21) Appl. No.: 18/254,088

(22) PCT Filed: Nov. 24, 2021
(86) PCT No.: PCT/EP2021/082745

§ 371 Date: May 23, 2023

(30) Foreign Application Priority Data
Nov. 25, 2020 (WO) PCT/CN2020/131487

(51) Int. Cl. C08G 18/12; C08G 18/44; C08G 18/32; C08G 18/22; C08G 18/24

(52) U.S. Cl. CPC C08G 18/12; C08G 18/44; C08G 18/244; C08G 18/227; C08G 18/3206

(57) ABSTRACT

A thermoplastic polyurethane is a reaction product obtained from components including (A) an aliphatic polyisocyanate, (B) an aliphatic polyol having at least one side chain, and (C) chain extenders. The aliphatic polyol (B) is a polycarbonate diol of formula (I):

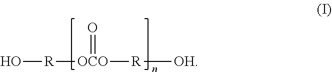

In formula (I), n is 4 to 40, and n+1 Rs are composed of a linear alkylene and an alkylene having at least one side chain so as to have the molar ratio of the linear alkylene to the alkylene having at least one side chain in the range of 0:100 to 95:5. The chain extender (C) is a combination of 1,4-butanediol with 1,3-propanediol, 1,5-pentanediol, 3-methyl-1,5-pentanediol, or ethylene glycol, and the amount of 1,4-butanediol is 50% by mass or more based on the total amount of the chain extenders (C). A resin composition containing the thermoplastic polyurethane and a corresponding molded product are also provided.

### TECHNICAL FIELD

The present invention relates to a thermoplastic polyurethane, particularly, a thermoplastic polyurethane made from an aliphatic isocyanate, a resin composition containing the thermoplastic polyurethane, and a molded product obtained therefrom.

### BACKGROUND ART

Thermoplastic Polyurethane (TPU) is a general-purpose plastic material that is widely used for industrial products (for example, automobile parts and paints), building materials, and articles for daily use. This is because TPU has characteristics such as mechanical strength and flexibility. It is known that TPU comes to have different properties depending on the type of polyisocyanate used as a raw material therefore and thus TPU can have a wide range of applications.

Polyurethane made from aromatic polyisocyanate can be prepared with a high efficiency and a low cost. For example, polyurethane, usually with being colored, is used as a coating material or a molding material such as hoses/tubes, films/sheets, sports shoe soles, tire parts of casters.

In addition, polyurethane made from aliphatic isocyanate have a relatively high level of weather resistance and yellowing resistance. Thus, polyurethane is widely used in the fields where both predetermined strength and appearance are of high significance, for automobile parts, paints, building materials, ornaments, or the like. Of these polyurethanes, polyurethane obtained from alicyclic polyisocyanate (for example, a hydrogenated diphenylmethane diisocyanate (H12MDI)) is known to have particularly excellent transparency, and less likely to have yellowness (Patent document 1).

In contrast, polyurethane obtained from a linear aliphatic polyisocyanate (for example, hexamethylene diisocyanate (HDI)), which is translucent or opaque exhibits an excellent processability. Hence, such polyurethane is often used to prepare molded products having various shapes (Patent document 2).

### PRIOR ART DOCUMENT

### Patent Document

### [Patent Document 1] JP-A 2020-007556

### [Patent Document 2] JP-A 2019-137789

### SUMMARY OF INVENTION

### Problems to be Solved by the Invention

The polyurethane disclosed in Patent document 1, which is obtained from alicyclic polyisocyanate, is effective for producing extruded products having an excellent transparency, for example, films and sheets. On the other hand, by way of injection moldings, it has been observed that the molded products tend to be shrunk and the process requires a long cooling time. In other words, the formability of the alicyclic polyisocyanate-based polyurethane is not satisfactory, whereby this type of polyurethane would not be properly processed with injection molding.

Further, polyurethane disclosed in Patent document 2, which is obtained from linear aliphatic polyisocyanate, is prone to be opaque because of its high crystallinity.

With the above discussed situation taken into consideration, it is an object of the present invention to provide a thermoplastic polyurethane having a good processability, as well as an excellent transparency, with mechanical properties being comparable to those of known polyurethanes. Another object of the present invention is to provide a resin composition comprising the above-mentioned thermoplastic polyurethane, and a further object of the invention is to provide a molded product obtained from the resin composition.

### Means for Solving the Problem

The inventors of the present invention have found that the object of the invention is solved by a thermoplastic polyurethane as a reaction product of components comprising (A) an aliphatic polyisocyanate, (B) an aliphatic polyol having at least one side chain, and (C) chain extenders. As the aliphatic polyol having at least one side chain (B), a polycarbonate diol represented by formula (1) is used:

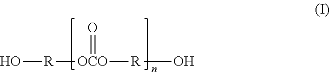

wherein n is 4 to 40, and n+1 Rs are composed of a linear alkylene, and an alkylene having at least one side chain so as to have a molar ratio of the linear alkylene to the alkylene having at least one side chain in the range of 0:100 to 95:5. The chain extenders (C) is a combination of 1,4-butanediol with at least one further diol selected from a group consisting of 1,3-propanediol, 1,5-pentanediol, 3-methyl-1,5-pentanediol and ethylene glycol, and the amount of 1,4-butanediol is set to be 50% by mass or more, based on the total amount of the chain extenders(C).

The aliphatic polyisocyanate (A) is preferably hexamethylene diisocyanate.

It is preferable that the linear alkylene is C₂-C₁₆ alkylene, and the alkylene having at least one side chain is C₃-C₁₈ alkylene.

It is preferable that the linear alkylene is C₄-C₈ alkylene, and the alkylene having at least one side chain is C₃-C₁₀ alkylene composed of C₃-C₈ alkylene as a main chain with one or two C₁-C₃ alkyl group as the side chain.

It is preferable that the chain extenders (C) are a combination of 1,4-butanediol with at least one further diol selected from a group consisting of 1,3-propanediol, 1,5-pentanediol, 3-methyl-1,5 pentanediol and ethylene glycol so as to have a mass ratio of 1,4-butanediol to the further diol in the range of 50:50 to 95:5.

It is preferable that the components for the reaction further comprises a catalyst(D) selected from a group consisting of tin(II) bis(2-ethylhexanoate), bismuth(III) neodecanoate and a combination of these.

The above-mentioned another object of the present invention is achieved by a polyurethane resin composition comprising any of the above thermoplastic polyurethanes and an antioxidant(E).

The above-mentioned further object of the present invention is achieved by a molded product obtained from the above polyurethane resin composition. Preferable examples of the molded product include a cover for an electronic device, a gearshift knob for an automobile, a grip for a tool, or a wristband.

### Effects of Invention

The thermoplastic polyurethane of the present invention has satisfactory mechanical properties and a transparency. This thermoplastic polyurethane can be processed into a molded product with a minimized yellowness not only immediately after the molding, but also a time being elapsed. In addition, the polyurethane of the present invention exhibits an excellent processability, and further the above-mentioned excellent mechanical properties even without the use of any additives. Further, the polyurethane composition with the optimized use of a catalyst and an additive has an improved yellowness resistance against sebum/oil or the like.

### DETAILED DESCRIPTION OF INVENTION

A thermoplastic polyurethane of the present invention is obtained as a reaction product of:
(A) an aliphatic polyisocyanate (also referred to as component (A)),
(B) an aliphatic polyol having at least one side chain (also referred to as component (B)), and
(C) chain extenders (also referred to as component (C)).

### [(A) Aliphatic Polyisocyanate]

An aliphatic polyisocyanate (A) is a linear or branched hydrocarbon compound containing two or more isocyanate groups. Specific examples of the aliphatic polyisocyanate (A) include ethylene diisocyanate, tetramethylene diisocyanate, hexamethylene diisocyanate (HDI), dodecamethylene diisocyanate, 2,2,4-trimethylhexamethylene diisocyanate, undecane-1,6,11-triisocyanate, lysine diisocyanate, 2,6-diisocyanatomethyl caproate, bis(2-isocyanatoethyl) fumarate, bis(2-isocyanatoethyl) carbonate, 2-isocyanatoethyl-2,6-diisocyanatohexanoate.

In the present invention, it is preferable to use a linear bifunctional isocyanate such as ethylene diisocyanate, tetramethylene diisocyanate, hexamethylene diisocyanate (HDI), and dodecamethylene diisocyanate, as the aliphatic polyisocyanate (A). A mixture of these can also be used as the (A) aliphatic polyisocyanate. Of these compounds, hexamethylene diisocyanate is particularly preferable.

The blending ratio of the aliphatic polyisocyanate (A), for the production of the thermoplastic polyurethane, is generally 15 to 45% by mass, preferably 20 to 35% by mass, based on the total mass of components involved in a reaction for producing the polyurethane, in particular, the components (A) to (C). In the above ranges, for example, when 15% by mass or more of the aliphatic polyisocyanate is used (A), cooling time during injection molding is shortened, and when 45% by mass or less thereof is used, the transparency is improved.

### [(B) Aliphatic Polyol Having at Least One Side Chain]

Polycarbonate diol of following formula (1):

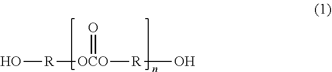

is used as the aliphatic polyol having at least one side chain (B).

In above formula (1), n is in the range of 4 to 40, preferably in the range of 7 to 20. Having one R in each repeating unit, n+1 Rs (i.e., plurality of R, or n+1 occurrences of R) can be different from one another, and Rs are composed of, or more preferably consists only of a linear alkylene/alkylenes and an alkylene/alkylenes having at least one side chain in a ratio (molar ratio) of 0:100 to 95:5, preferably 70:30 (linear alkylene/alkylenes:alkylene/alkylenes having at least one side chain).

When the ratio of the linear alkylene is 0, all Rs consist only of alkylene(s) having at least one side chain. In contrast, when Rs in formula (1) are both the linear alkylene and the alkylene having at least one side chain (also referred to as a branched alkylene), the linear alkylene and the branched alkylene are randomly (in general) contained in the polycarbonate diol of formula (1).

The linear alkylenes as Rs are generally C₂-C₁₆ alkylene, preferably C₁-C₁₂ alkylene, and more preferably C₄-C₈ alkylene. The alkylene having at least one side chain is generally C₃-C₁₈ alkylene, preferably C₃-C₁₂ alkylene, and more preferably C₅-C₈ alkylene.

Of these, for example, C₃-C₁₈ alkylene having at least one side chain (branched C₃-C₁₈ alkylene) refers to that that the total number of carbon atoms in a main chain and the side chain of the alkylene is 3-18.

The branched C₃-C₁₈ alkylene is a structural part of formula (1) having a main chain, e.g. of C₃-C₁₇ alkylene and the side chain(s) of one or two C₁-C₃ alkyl group(s).

Examples of the branched alkylene include methylethylene, 2-methylpropylene, ethylethylene, 1,2-dimethylethylene, 1,1-dimethylethylene, 1-ethylpropylene, 2-ethylpropylene, 1,2-dimethylpropylene, 2,2-dimethylpropylene, 1-propylpropylene, 2-propylpropylene, 1-methyl-1-ethylpropylene, 1-methyl-2-ethyl-propylene, 1-ethyl-2-methyl-propylene, 2-methyl-2-ethyl-propylene, 1-methylbutylene, 2-methylbutylene, 3-methylbutylene, 2-ethylbutylene, 1-methylpentylene, 2-methylpentylene, 3-methylpentylene, 3,3-dimethylpentylene, 1-, 2-, 3-ethylpentylene, 1-, 2-, 3-ethylpentylene, 1-, 2-, 3-methylhexylene, 1-, 2-, 3-, 4 methylheptylene, methyloctylene, methylnonylene, methyldecylene, methylundecylene, methyldodecylene, methyltetradecylene, methyloctadecylene. Of these compounds, 2-methylpropylene, 2,2-dimethylpropylene, 3-methylpentylene and 3,3-dimethylpentylene are preferred, and 2,2-dimethylpropylene and 3-methylpentylene are particularly preferred.

As described above, the ratio of the linear alkylene to the alkylene having at least one side chain as the plurality of Rs of formula (1) can be 0:100 to 95:5, with the chain length of each alkylene chain, etc. taken into account. In other words, a part of the plurality of Rs can be a linear alkylene(s), but at least 5 mol % of all R has to be alkylene(s) having at least one side chain.

The linear alkylenes as R may be a combination of multiple types of linear alkylenes. The alkylenes having at least one side chain may also be a combination of multiple types, e.g., two or three types of alkylenes having at least one side chain. When the ratio of the alkylene having at least one side chain is at least 5 mol %, preferably at least 30 mol %, more preferably at least 60 mol %, and particularly preferably 90 mol %, based on all (n+1) Rs, the haze value can be reduced, of a polyurethane molded product as a final product. The reduced haze value is beneficial for the production of a transparent molded product where the transparency with or without being colored improves esthetics of the product. The haze value of a product becomes excellent, which is made from polyurethane prepared from polycarbonate diol of formula (1) where all Rs are an alkylene having at least one side chain or contain a linear alkylene only at a small ratio. Accordingly, a molded product with a decreased haze value can be obtained.

The polycarbonate diol of formula (1) has a number-average molecular weight Mn of preferably 800 to 3500, more preferably 900 to 3000, and even more preferably 1000 to 2000. From the material having the number average molecular weight within the above ranges, molded products with highly improved transparency can be prepared through a satisfactorily shortened cooling time in injection molding.

In the present invention, the number average molecular weight Mn is determined by:

Mn=(56100×valence)/hydroxyl value.

In the above expression, the valence refers to the number of hydroxyl groups in a molecule. Then, the valence of polycarbonate diol in formula (1) is 2. Further, the hydroxyl value is measured according to JIS K 1557 (Method B).

### [(B) Method for Producing an Aliphatic Polyol Having at Least One Side Chain]

The aliphatic polyol having at least one side chain is produced by reacting an alcohol component(s) including a linier diol (e.g. C1-C18 alkylene diol) and a diol having at least one side chain (for example, C₃-C₁₈ branched diol), with carbonate diester (for example, dimethyl carbonate). Herein, the linier diol and the diol having at least one side chain correspond to those discussed in connection with R in formula (1), respectively.

The alcohol component and dimethyl carbonate in equimolar ratio are subjected to a transesterification reaction in the presence of a catalyst. Through the reaction, a polycarbonate polyol of formula (1) having an alkyl group such as one or two methyl, ethyl, or propyl group(s)) as at least one side chain can be obtained. The side chain such as alkyl group in polycarbonate is derived from at least one side chain in the branched alcohol used as raw material of the above reaction. Thus, the selection of the ratio of a branched alcohol and a linear alcohol, based on the entire alcohol component is important to control the proportion of the side chain(s) in the polycarbonate polyol.

The reaction temperature during the transesterification reaction is not particularly limited so far as a practical reaction rate can be obtained. The lower limit of the reaction temperature is usually 70° C., preferably 100° C., and more preferably 130° C. The upper limit of the reaction temperature is usually 250° C., preferably 200° C., more preferably 190° C., even more preferably 180° C., and particularly preferably 170° C. The reaction pressure at the completion of reaction is not particularly limited, but the upper limit at that point of time is usually 10 kPa, preferably 5 kPa, and more preferably 1 kPa.

In the production of the thermoplastic polyurethane according to the present invention, the blending ratio of the aliphatic polyol having at least one side chain (B) is generally 50 to 80% by mass, preferably 55 to 75% by mass, based on the total mass of components (particularly components (A) to (C)) involved in the reaction for preparing the polyurethane.

### [(C) Chain Extenders]

The chain extenders (C) contain 1,4-butanediol (BDO), and a further diol including at least one of 1,3-propanediol (PDO), 1,5-pentanediol, 3-methyl-1,5-pentanediol (MPD), or ethylene glycol. The amount of 1,4-butanediol is 50% by mass or more based on the total amount of the chain extenders (C).

The use of two or more types of chain extenders improves the transparency of a molded product made from polyurethane. When the amount of 1,4-butanediol is 50% by mass or more, transparency, in addition to good processability (in particular, the appearance of a molded product and cooling time) can be improved.

As the chain extenders (C), 1,4-butanediol (referred to as a first chain extender), and 1,3 propanediol, 1,5-pentanediol, 3-methyl-1,5-pentanediol or ethylene glycol (referred to as a second chain extender) are used preferably in the range of 60:40 to 95:5, and more preferably in the range of 65:35 to 85:15. In particular, the used of 1,4-butanediol as the first chain extender and 1,3-propanediol or 3-methyl-1,5-pentanediol as the second chain extender is preferred, even more preferably with the mass ratio of the first chain extender to the second chain extender being set in the range of 60:40 to 95:5, and still further preferably in the range of 70:30 to 85:15.

The use of the chain extenders (C) in the above range gives excellent transparency to the product obtained from the polyurethane, simultaneously with restricting not only the initial yellowness but also yellowing which could be added over time. Further, within the above-mentioned range, processability required for well mold the polyurethane is maintained in an excellent level. When the amount of the second chain extender is 80% or more based on the total mass of the chain extenders (C), transparency is particularly improved because of so-called even-odd effect or the influence of the side chain.

As described above, the chain extenders (C) are used in combination of two or more different diols. Further, other chain extenders having low molecular weight (Mw<60), for example short-chain diols such as 1,2-ethanediol, 1,5-pentanediol, 1,6-hexanediol, neopentyl glycol, diethylene glycol, and dipropylene glycol can be used, so far as the effects of the present invention are obtained.

The blending ratio of the chain extenders (C) in the production of the thermoplastic polyurethane according to the present invention is generally 3 to 25% by mass, preferably 7 to 15% by mass, based on the total mass of components involved in a reaction for producing the polyurethane (in particular, the components (A) to (C)).

### [Manufacturing of Thermoplastic Polyurethane (TPU)]

The thermoplastic polyurethane can be produced according to known methods, by using the above components (A) to (C) as raw materials, optionally with a catalyst, a cross-linking agent, a cross-linking aid or the like. Polyurethane may be produced in batches or continuously, both of which are carried out by known methods.

In the continuous method, polyurethane is produced, for example by use of a reaction extruder(s), in accordance with a one-shot method, a prepolymer method or the like. In general, the one-shot method is preferably used with the production cost and time taken into account. On the other hand, a semi-prepolymer method and a prepolymer method may also be used in order to proceed with a reaction to obtain products with uniform qualities and improved transparency. In these methods, the reaction components are mixed continuously, wherein each component reacts immediately after being mixed, in general. When an extruder such as a twin-screw extruder is used, the components (A) to (C), and additionally a catalyst and/or a further substance which may be added are loaded into an extruder, individually or in the form of a preliminarily mixed state. The temperature of an extruder is increased to 120-240° C., preferably 150-220° C. Thereafter, the resulting polyurethane is extruded, followed by being cooled and pelletized.

From the view-points of durability and moldability, it is preferable that the thermoplastic polyurethane has a weight-average molecular weight Mw in the range of preferably 80,000 to 250,000, more preferably 100,000 to 150,000.

The molecular weight can generally be controlled by adjusting the ratio of the molar amount of OH component (polyol and chain extenders) to the molar amount of polyisocyanate component. The molecular weight can also be controlled by adding monool (mono alcohol) such as methanol, ethanol, propanol, butanol, 2-ethylhexyl alcohol to the reaction system. Herein, the molecular weight of polyurethane is determined with GPC method (gel permeation chromatography), using polystyrene as a standard polymer, THE as an eluent, the sample solution being prepared to have a concentration of about 0.1%. The determination was made by use of HLC-8220 GPC manufactured by TOSOH CORPORATION, wherein a flow rate of 0.35 ml/min, and temperature of 40° C. are set, over the measurement time of 15 minutes. The same applies to the Examples described below.

As described above, the polyurethane according to the present invention is generally prepared in the form of pellets, but may be in the form of powder. Subsequent processing of the polyurethane may be carried out by a known method such as injection molding, calendaring or extruding.

Further known materials such as catalysts, cross-linking agents, and cross-linking aids can be used in the production of the polyurethane according to the present invention. Types of the applicable materials are not particularly limited so far as the object of the present invention can be achieved.

Specific examples of the catalysts include tin-containing organometallic compounds, for example, dibutyl tin dilaurate (DBTDL), dioctyl tin dilaurate, dibutyl tin diacetate, tin(II) bis (2-ethylhexanoate); titanic acid esters; zirconium compounds; bismuth-containing organometallic compounds, for example, bismuth carboxylates including bismuth (III) neodecanoate and bismuth (III) 2-ethylhexanoate; iron-containing organometallic compounds; amine-based catalysts, for example, triethylamine, triethylenediamine, N-methylimidazole, N-ethylmorpholine, 1,8-diazabicyclo [5,4,0]-7-undecene (DBU)); potassium acetate; phosphorus compounds, for example, tributylphosphine, phosphorene and phosphorene oxide. These can be used alone or in combination of two or more. In the present invention, the use of a tin-containing organometallic compound and a bismuth-containing organometallic compound, in particular, a bismuth-containing organometallic compound is preferred, for reducing an initial yellowness (YI value) of the molded product from the polyurethane, and particularly for obtaining an excellent yellowing resistance against components including oils such as sweat and sebum.

The total amount of the catalyst to be used is preferably 5% by mass or less, more preferably in a range of 0.001% by mass to 2% by mass, based on the total mass of the components (A) to (C).

As described above, a thermoplastic polyurethane can be produced which exhibits an excellent transparency, yellowing resistance, and excellent processability. Accordingly, the thermoplastic polyurethane according to the present invention can be molded as a single component material, without further use of additives, and the resultant molded product exhibits excellent transparency and yellowing resistance. On the other hand, it is still possible to add additives to the polyurethane, if some specific control is necessary.

In the present invention, total light transmittance (Tt) according to JIS K 7361-1: 1997 and haze according to JIS K 7136: 2000 are used for evaluating the transparency.

### [Thermoplastic Polyurethane Composition]

To the thermoplastic polyurethane according to the present invention, it is possible to add one or more additives, including antioxidants, light stabilizers, UV absorbers, nucleating agents, surface modifiers, optical brighteners, lubricants, anti-hydrolysis agents, crosslinkers, antistatic agents, anti-blocking agents, heat stabilizers, flame retardants, heat resistance improvers, weather resistance improvers, reaction retarders, plasticizers, conductivity imparting agents, antibacterial agents, antifungal agents, inorganic and organic fillers, fiber-based reinforcements and colorants. Thermoplastic polyurethane compositions with variety of properties can be obtained depending upon the application or intended use, by use of the above additives.

As additives for imparting weather resistance, antioxidants, light stabilizers, ultraviolet inhibitors, or a combination of two or more of those may be added to the polyurethane, depending on the intended use of the polyurethane composition. Generally speaking, polyurethanes produced from aromatic polyisocyanate are prone to have yellowness influenced with ultraviolet rays. To the contrary, the polyurethane according to the present invention exhibits excellent yellowing resistance and discoloration resistance even without using antioxidants and ultraviolet protection agents.

Antioxidants are preferably added to the polyurethane or polyurethane composition when a molded product therefrom is to be exposed to outdoor use, other environmental conditions where an oxidative deterioration is anticipated, or application style through which sebum from hands, fingers, etc may easily adheres. The type of antioxidants is not particularly limited, and known materials can be used. As the antioxidant, phenolic antioxidant is effectively used, in particular, to reduce the influence of sebum. Examples of phenolic antioxidants are described in the “Plastic Additives Handbook” (5th Edition, H. Zweifel, Hanser Publisher, Munich, 2001, pp. 98-107, 116-121). Phenolic antioxidant having a molecular weight of more than 700 g/mol is preferably used. Moreover, the use of a hindered phenolic antioxidant is particularly preferred. Specific examples of the hindered phenolic antioxidant include pentaerythrityltetrakis (3-(3,5-bis (1,1-dimethylethyl)-4-hydroxyphenyl) propionate) (Irganox (Trademark) 1010, manufactured by BASF Japan Ltd.), octadecyl-3-(3,5-di-tert-butyl-4-hydroxyphenyl) propionate (Irganox (Trademark) 1076, manufactured by BASF Japan Ltd.), N, N′-hexane-1,6-diylbis-3-(3,5-di-tert-butyl-4-hydroxyphenylpropionamide) (Irganox (Trademark) 1098, manufactured by BASF Japan Ltd.).

In addition, phosphorus-based antioxidants (for example, tris (2,4-di-tert-butylphenyl) phosphite (Irgafos (Trademark) 168, manufactured by BASF Japan Ltd.), vitamin E-based antioxidants (for example, 3,4-dihydro-2,5,7,8-tetramethyl-2-(4,8,12-trimethyltridecyl)-2H-benzopyran-6-ol (Irganox (Trademark) E 201, BASF Japan Ltd.)) can also be used.

The use of amine-based antioxidants is not preferred, when the polyurethane or polyurethane composition should not be colored.

It is possible to use the antioxidants in an amount of 0.01 to 2% by mass, preferably 0.1 to 1% by mass, particularly 0.1 to 0.5% by mass, based on the total mass of the thermoplastic polyurethane.

Further, ultraviolet absorbers may be added to the polyurethane composition as discussed above. The type of the ultraviolet absorber is not particularly limited, and known material can be used. Specific examples of the ultraviolet absorbers include cinnamic ester, diphenyl cyanoacrylate, formamidine, benzylidene malonate, diarylbutadiene, triazine-based and benzotriazole-based UV absorbers (for example, Tinuvin (Trademark) 329, manufactured by BASF Japan Ltd.).

As described above, the polyurethane according to the present invention exhibits excellent yellowing resistance even without relying on ultraviolet absorbers. Therefore, ultraviolet absorbers are not usually added to the polyurethane. In contrast, ultraviolet absorbers are preferably used when a molded product is constantly exposed to strong ultraviolet rays, such as that for outdoor installation. Even for such occasions, triazine-based UV absorber having its own strong yellowish color is not preferred to be added to the composition, if the product molded from the composition should not have an initial yellowness.

UV absorber may be used as a single substance, or as a mixture of two or more types. The concentration of the UV absorber used may be 0.01 to 3% by mass, more preferably 0.1 to 2.0% by mass, and particularly 0.1 to 1.0% by mass, based on the mass of polyurethane. When the concentration of the UV absorber is 0.01% by mass or more, the effect of ultraviolet absorption is increased. When the concentration is 0.3% by mass or less, yellowing and coloring resulting from sebum can be reduced.

Likewise, a light stabilizer may be added to the polyurethane according to the present invention, as discussed above. The type of light stabilizer is not particularly limited, and known materials can be used. A hindered amine light stabilizer (HALS) may be used as the light stabilizer. Examples of the HALS stabilizers as commercially available products are described in the “Plastic Additives Handbook” (5th Edition, H. Zweifel, Hanser Publishing Co., Munich, 2001, pp. 123-136). The hindered amine light stabilizer has a number-average molecular weight of preferably 500 g/mol to 10000 g/mol, more preferably 1000 to 5000 g/mol. Particularly preferable hindered amine photostabilizers are bis (1,2,2,6,6-pentamethyl piperidyl) sebacate (Tinuvin (Trademark) 765, manufactured by BASF Japan Ltd.), a condensation product of 1-hydroxyethyl-2,2,6,6-Tetramethyl-4-hydroxypiperidine and succinic acid (Tinuvin (Trademark) 622, manufactured by BASF Japan Ltd.), polymer sterically hindered amine (Chisorb (Trademark) 622LT, Double Bond Chemical Ind., Co., Ltd.). A condensation product of 1-hydroxyethyl-2,2,6,6-tetramethyl-4-hydroxypiperidine and succinic acid (Tinuvin (Trademark) 622) is particularly preferably used. The concentration of HALS compound used is preferably 0.01 to 3% by mass, more preferably 0.1 to 2.0% by mass, and even more preferably 0.1 to 1.0% by mass, based on the mass of polyurethane.

Further, nucleating agents can be added to the polyurethane according to the present invention. The type of the nucleating agents is not particularly limited, and known nucleating agents can be used. Specific examples include dibenzylidene sorbitol-based nuclear agent (for example, Millad (Trademark) NX8000 manufactured by Milliken Chemical Co. Ltd.), benzoic acid metal salt-based nucleating agent, a phosphate ester salt-based nucleating agent, and a rosin-based nucleating agent. The blending ratio of nucleating agents can be 0.3% by mass or less, more preferably 0.1 to 0.25% by mass, based on the mass of polyurethane. When the amount of the nucleating agent to be added is 0.3% by mass or less, the resultant polyurethane molded product becomes excellent in terms of haze value and yellowing resistance.

A Surface modifier can be used as a further additive in the polyurethane according to the present invention. The type of the surface modifier is not particularly limited, and known surface modifiers such as wax or lubricant can be used. Specific examples include petroleum-derived hydrocarbon waxes, for example, ozokerite, paraffin wax, montanic acid ester wax, animal wax such as bees wax, shellac wax, wool wax, or vegetable wax such as carnauba wax, candelilla wax, rice wax, fatty acid amide wax such as ethylene bis stearamide (EBS), N, N′ ethylene bis oleamide (EBO), or erucamide, polyolefin wax such as polyethylene wax, polypropylene wax, Fischer-Tropsch wax, polyethylene oxide wax and modified-polyolefin waxes such as graft- or copolymer-type polyolefin. In addition, acrylic polymer lubricants (for example, Metabrene L1000 manufactured by Mitsubishi Chemical Corporation) can be used as surface modifiers. In the present invention, a montanic acid ester wax (for example, Licolub WE4 manufactured by Clariant Japan Co., Ltd.) and an acrylic polymer lubricant are particularly preferably used. As a result, the product molded from the polyurethane will have improved lubricating property and a good mold releasability. Further, bleeding-out phenomenon over time can be restricted by adjusting the amount of the additives.

As described above, a surface modifier can be added alone or in combination of two or more types. The amount of the surface modifier can be 0.01 to 1% by mass, preferably 0.01 to 0.5% by mass, based on the mass of the polyurethane.

Known colorants can be added to the polyurethane composition according to the present invention. The types thereof are not particularly limited. A blue pigment can also be used as bluing agent in order to reduce initial yellowness. In addition, appearance of the polyurethane composition can be further improved by the joint use of a fluorescent whitening agent.

### [Preparation of Polyurethane Composition]

For preparing a polyurethane composition, a predetermined amount of one or more additives are appropriately metered into the thermoplastic polyurethane obtained as discussed above, followed by mixing by the aid of a known blending device and installation including a kneader and a mixer. The polyurethanes of according to the present invention is generally processed into the form of pellets or powders in accordance with a known method such as injection molding, calendaring, or extrusion. For example, polyurethane is supplied into a post-extruder, and then usually kneaded and melted at a temperature of about 150 to 230° C. in an ambient atmosphere. Thereafter, polyurethane is extruded into a desired shape. A twin-screw mixer, a continuous single-screw or twin-screw mixer including a continuous kneading extruder can be used.

The polyurethane composition may be in the form of powder, flakes, rods, sheets, or blocks, or alternatively in the form of pellets or granules through e.g. strand cutting or underwater cutting.

### [Manufacturing of Molded Products]

The thus obtained polyurethane composition is molded into a product with a desired shape, for example, by using a suitable molding device or a mold. A known molding devices or molds can be appropriately used so far as the polyurethane composition can be molded into a desired shape.

The application of the molded product obtained from the polyurethane resin composition is not particularly limited. Having high mechanical properties such as tensile strength and tear strength, as well as excellent transparency and less likeliness to have yellowing over time, the molded product is applicable, particularly to covers including coverings for and casings of electronic devices such as smartphones and tablets, a gearshift knob for automobiles and a grip of a tool, and wristbands, for example those for watches.

The present invention will now be explained with reference to Examples, to which present invention is not limited. Unless otherwise specified, “parts” and “%” are based on mass.

### Examples

### Examples 1 to 6, Comparative Examples 1 to 3

### <Preparations of Samples for Evaluating Mechanical and Optical Properties>

The following operations were carried out by use of the materials listed in Table 1 in amounts shown therein for the Examples and the Comparative Examples. Polyol (component (B)) and chain extenders (component (C)) were metered into a cylindrical 2 L size metal container and heated to a temperature in the range of 90 to 95° C. An antioxidant, a light stabilizer, a UV absorber, a lubricant, a nucleating agent, and a catalyst were added and stirred at 200-300 rpm until the mixture was uniformly mixed. Then, a predetermined amount of isocyanate component (component (A)) preliminarily heated at 50° C. was loaded in the container, and stirring was continued until the temperature reached 105° C.

After reaching 105° C., the thus obtained liquid material was transferred to a Teflon (Trademark) container and then annealed at 95° C. for 15 hours to increase the molecular weight into a polymer. Accordingly, the thermoplastic polyurethane resin in the form of a slab was obtained. The slab was cut and pulverized to form flakes.

The flakes were fed into a twin-screw extruder (manufactured by WERNER & PFLEIDERER, ZSK30: 30 mmφ) from a feeder. The temperature in the region from a hopper to a die head was set to be 180-210° C. The flakes were melted and kneaded simultaneously with being extruded in the form of strands, while the screw was rotating at a rotation speed of 100 to 110 rpm. The strands were brought in a water tank, cooled therein, and then cut with a pelletizer to continuously obtain a uniformly made pellet-shaped polyurethane composition.

The above polyurethane composition was subjected to injection-molding by using an injection molding machine (TM130F2: manufactured by Toyo Machinery & Metal Co., Ltd.) under the following conditions. As for the molding temperature, the nozzle tip of the injection molding machine was set to have a temperature in the range of 200 to 210° C. The temperatures of the cylinders were sequentially lowered by 5° C., toward hopper side. The temperature of the lower part of the hopper was set to be 180 to 190° C. The mold temperature was set at 25° C.

The polyurethane composition was heated and melted, and then injected by use of a 40 mm φ screw, at an injection speed: 10% (11 mm/sec), and at an injection pressure: 90 kgf/(1130 kgf/cm²). After holding the pressure of 80 kgf/(1070 kgf/cm²) for 40 seconds to cool the mold, a plate-shaped molded product of 160 mm (length)×105 mm (width)×2 mm (thickness) was obtained. All test samples were found to have excellent surface smoothness with no dents or scratches thereon. These samples were used for evaluating Shore A hardness, impact resilience, and specific gravity. The same samples were also used to evaluate optical properties.

Further, dumbbell-shaped test pieces and right-angled tear test pieces described in JIS K 7311-1995 were prepared from the polyurethane compositions of the Examples and Comparative Examples. Their pieces were used as samples for evaluating tensile strength and tear strength. The following tests were carried out to confirm that these samples had good surface smoothness and satisfied predetermined evaluation standards for the tests.

### <Evaluation of Mechanical Properties>

The text samples were subjected to the measurements according to JIS K 7311-1995 for determining mechanical properties of the molded products, that is, Shore A hardness, tensile strength, elongation at break, and tear strength.

Shore A hardness was measured by use of 3 stacked test samples to have a total thickness of 6 mm for each of the Examples and Comparative Examples, by use of type A durometer.

The evaluation results of mechanical properties are shown in Table 1.

### <Evaluation of Optical Properties>

Optical properties, that is, total light transmittance and haze are evaluated on molded product obtained from the polyurethane of the present invention were evaluated by using the afore mentioned plate-shaped test samples.

The total light transmittance (Tt) was evaluated according to JIS K 7361-1: 1997. The Haze was evaluated according to JIS K 7136: 2000.

In general, the transparency of a substance, which can be affected by discoloration and/or haze thereof, is well perceived without significant variation, when the total light transmittance is 85% or more and the haze is 10% or less. Therefore, these percentage values for total light transmittance and haze is used as a reasonable standard for evaluating optical properties. Further, it is also possible to consider yellowing over time, when evaluating transparency. When the yellowing over time is taken into account, it is preferable that the degree of yellowness is 10 or less. It was confirmed that the samples of the present invention had satisfied the standard (YI≤10) based on which samples can be evaluated as preferable ones, and the yellowing was well restricted.

Regarding the yellowness degree (ΔYI), the samples were subjected to a pseudo-weather test for 15 days, by use of QUV-B accelerated weathering tester, manufactured by Q-Lab Corporation, wherein the samples were exposed to artificial sunlight, rainfall, and dew. The difference in yellowness of the samples before and after the exposure to the test was evaluated by determining the yellowness degree.

ΔYI=YI1−YI0
YI0: Initial yellowness of the samples (immediately after being molded)
YI1: Yellowness of samples immediately after the weather resistance test

Yellowness was measured in accordance with JIS K7373: 2006.

ΔYI as a positive value refers to the increase of yellowness degree. In other words, the smaller value ΔYI, the smaller the yellowness degree.

### <Evaluation of Processability>

Processability was evaluated using an injection molding machine (TM130F2: manufactured by Toyo Machinery & Metal Co., Ltd.). A molded product in the shape of a plate having 160 mm (length)×105 mm (width)×2 mm (thickness) was prepared at the above-mentioned molding temperature, injection speed the above-mentioned cooling time (40 sec). The processability was evaluated on the basis of the cooling time and the appearance/external shape.
⊚: Short cooling time (within 20 seconds) and good appearance
∘: Acceptable processing time (within 30 seconds) and no major problem in appearance
Δ: Slight deformation/contraction observed
x: Large deformation/contraction observed

The test results are shown in Table 1.

TABLE 1

| | | | | | | | | Com- | Com- | Com- |
|---|---|---|---|---|---|---|---|---|---|---|
| | | | | | | | | para- | para- | para- |
| | | | | | | | | tive | tive | tive |
| | | Exam- | Exam- | Exam- | Exam- | Exam- | Exam- | Exam- | Exam- | Exam- |
| Components | | ple 1 | ple 2 | ple 3 | ple 4 | ple 5 | ple 6 | ple 1 | ple 2 | ple 3 |
| (A) | HDI | 25 | 25 | 25 | 25 | 25 | 25 | 25 | 25 | 25 |
| (B) | PCD1 (NPG:BDO = | 65 | 65 | 65 | | | | | | |
| | 30:70 mol %) | | | | | | | | | |
| | PCD2 (MPD:HDO = | | | | 65 | | | | | |
| | 90/10 mol %) | | | | | | | | | |
| | PCD3 (MPD:HDO = | | | | | 65 | 65 | | | |
| | 99/1 mol %) | | | | | | | | | |
| | PCD4 (HDO:100 mol | | | | | | | 65 | | 65 |
| | %) | | | | | | | | | |
| | PCL1 | | | | | | | | 65 | |
| (C) | BDO | 9 | 8.5 | 9 | 8.5 | 7 | 7 | 10 | 10 | 7 |
| | PDO | 1 | 1.5 | 1 | 1.5 | 3 | | | | 3 |
| | MPD | | | | | | 3 | | | |
| (D) | DBTDL | 0.003 | 0.003 | 0.003 | 0.002 | 0.002 | 0.002 | 0.002 | 0.002 | 0.002 |
| | NX8000 | | | 0.3 | | | | | | |
| | Licolub WE4 | 0.04 | 0.04 | 0.04 | 0.04 | 0.04 | 0.04 | 0.04 | 0.04 | 0.04 |
| | lrg1010 | 0.1 | 0.1 | 0.1 | 0.1 | 0.1 | 0.1 | 0.1 | 0.1 | 0.1 |
| | Tin329 | 0.1 | 0.1 | 0.1 | 0.1 | 0.1 | 0.1 | 0.1 | 0.1 | 0.1 |
| | Chisorb622LT | 0.1 | 0.1 | 0.1 | 0.1 | 0.1 | 0.1 | 0.1 | 0.1 | 0.1 |
| Evalu- | Shore A hardness | 94 | 94 | 94 | 94 | 93 | 93 | 95 | 96 | 93 |
| ation | Tensile strength (MPa) | 54 | 52 | 55 | 56 | 45 | 51 | 57 | 56 | 40 |
| | Elongation at break | 520 | 610 | 640 | 560 | 580 | 560 | 510 | 650 | 590 |
| | (%) | | | | | | | | | |
| | Tear strength (kN/m) | 143 | 141 | 147 | 95 | 87 | 84 | 149 | 170 | 139 |
| | Processability | ◯ | ◯ | ◯ | ⊚ | ⊚ | ⊚ | ⊚ | ⊚ | Δ |
| | Haze (%) | 3.1 | 1.8 | 2.1 | 2.9 | 2.3 | 2.6 | 10.6 | 26.0 | 7.8 |
| | Total light | 90.5 | 90.6 | 90.7 | 89.4 | 90.1 | 90.2 | 83.4 | 83.6 | 86.7 |
| | transmittance (%) | | | | | | | | | |

The abbreviations in Table 1 are as follows:
HDI: Hexamethylene diisocyanate
PCD1: Polycondensate (Mn = 2000) of NPG/BDO = 30/70 mol % and DMC
PCD2: Polycondensate (Mn = 2000) of MPD/HDO = 90/10 mol % and DMC
PCD3: Polycondensate (Mn = 2000) of MPD/HDO = 99/1 mol % and DMC
PCD4: Polycondensate (Mn = 2000) of HDO 100 mol % and DMC
PCL1: Polycaprolactone diol (Mn = 2000)
NPG: Neopentyl glycol
BDO: 1,4-butanediol
MPD: 3-methyl-1,5-pentanediol
HDO: 1,6-hexamethylenediol
DMC: Dimethyl carbonate
PDO: 1,3-propanediol
DBTDL: Dibutyltin dilaurate
NX8000: Sorbitol compound of the following formula: 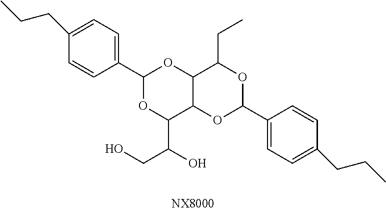 [SMILES: CCCc1ccc(C2OC(C(O)CO)C3OC(c4ccc(CCC)cc4)OC(CC)C3O2)cc1]
Irg1010: Irganox (Trademark) 1010 (manufactured by BASF Japan Ltd.); pentaerythrityl tetrakis (3-(3,5-bis (1,1-dimethylethyl)-4-hydroxyphenyl) propionate
Tin329: Tinuvin (Trademark) 329 (manufactured by BASF Japan Ltd.); 2-(2H-benzotriazol-2-yl)-4-(1,1,3,3-tetramethylbutyl) phenol
Chisorb622LT: Chisorb (Trademark) 622LT (manufactured by Double Bond Chemical Ind., Co., Ltd.); polymeric sterically hindered amine
Licolub WE4: Licolub (Trademark) WE4 (manufactured by Clariant Japan Co., Ltd.)

As shown in the Examples, the thermoplastic polyurethanes and the compositions of the present invention have excellent processability, and the molded products exhibit excellent transparency and restricted yellowness. Further, the mechanical properties of the molded products of the Examples are comparable to those of the polyurethanes in the Comparative Examples.

It should be appreciated that modifications and alterations of the novel polyurethane and composition described herein may be made, so far as they fall within the scope of the appended claims or the equivalents thereof.

1: A thermoplastic polyurethane, which is a reaction product of components comprising:
(A) an aliphatic polyisocyanate,
(B) an aliphatic polyol having at least one side chain, and
(C) chain extenders,
wherein the aliphatic polyol having at least one side chain (B) is a polycarbonate diol of formula (1): 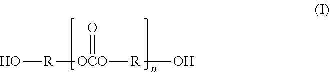
wherein n is 4 to 40, and n+1 Rs are composed of a linear alkylene and an alkylene having at least one side chain so as to have a molar ratio of the linear alkylene to the alkylene having at least one side chain in the range of 0:100 to 95:5, and
wherein the chain extenders (C) are a combination of 1,4-butanediol with at least one further diol selected from the group consisting of 1,3-propanediol, 1,5-pentanediol, 3-methyl-1,5-pentanediol, and ethylene glycol, wherein the amount of 1,4-butanediol is 50% by mass or more, based on the total amount of the chain extenders (C).

2: The thermoplastic polyurethane according to claim 1, wherein the aliphatic polyisocyanate (A) is hexamethylene diisocyanate.

3: The thermoplastic polyurethane according to claim 1, wherein the linear alkylene is C₂-C₁₆ alkylene, and the alkylene having at least one side chain is C₃-C₁₈ alkylene.

4: The thermoplastic polyurethane according to claim 1, wherein the linear alkylene is C₄-C₈ alkylene, and the alkylene having at least one side chain is C₃-C₁₀ alkylene composed of C₃-C₈ alkylene as a main chain with one of two C₁-C₃ alkyl group as the side chain.

5: The thermoplastic polyurethane according to claim 1, wherein the chain extenders (C) are a combination of 1,4-butanediol with at least one further diol selected from a group consisting of 1,3-propanediol, 1,5-pentanediol, 3-methyl-1,5-pentanediol, and ethylene glycol, so as to have a mass ratio of 1,4-butanediol to the at least one further diol in the range of 50:50 to 95:5.

6: The thermoplastic polyurethane according to claim 1, wherein the components further comprise a catalyst (D) selected from the group consisting of tin(II) bis(2-ethylhexanoate), bismuth(III) neodecanoate, and a combination of these.

7: A polyurethane resin composition, comprising:
the thermoplastic polyurethane according to claim 1, and
an antioxidant (E).

8: A molded product, obtained from the polyurethane resin composition according to claim 7.

9: The molded product according to claim 8, wherein the molded product is a cover for an electronic device, a gearshift knob of an automobile, a grip of a tool, or a wristband.
